(19) United States
(12) Patent Application Publication
(10) Pub. No.: US 2015/0199541 A1
(43) Pub. Date: Jul. 16, 2015

(54) METHOD AND SYSTEM FOR SECURED COMMUNICATION OF PERSONAL INFORMATION

(71) Applicant: 1FORM ONLINE PTY LTD, Prahran, Victoria (AU)

(72) Inventors: Christopher James Koch, Brighton (AU); Chad Anthony Stephens, Brighton (AU)

(73) Assignee: 1FORM ONLINE PTY LTD, Prahran, Victoria (AU)

(21) Appl. No.: 14/414,397

(22) PCT Filed: Jul. 2, 2013
(86) PCT No.: PCT/AU2013/000720

§ 371 Date: Jan. 12, 2015

Related U.S. Application Data
(60) Provisional application No. 61/671,207, filed on Jul. 13, 2012.

(30) Foreign Application Priority Data
Aug. 31, 2012 (AU) 2012903777

(51) Int. Cl. G06F 21/62; G06F 11/14

(52) U.S. Cl. CPC G06F 21/6263; G06F 11/1412; G06F 2201/84

(57) ABSTRACT

A method and system for securely communication of personal information is disclosed. In one embodiment, when a user wishes to instantly populate web form (204) displayed in a web browser (122), a populate button integrated into the rendered output of the website (123) displayed in the web browser (122) triggers a request for unique code to a remote server (104) via a wire less network (108). Accordingly, the server (104) generates a unique code and displays the unique code in the web browser (122). When a first computing device (102) receives the unique code inputted by the user, the first computing device (102) communicates the unique code to the server (104). Accordingly, the server (104) validates the unique code and establishes a connection between the second computing device (106) and the first computing device (102) upon validating the unique code. Then, the server (104) retrieves information stored in the first computing device (102) and instantly populates the information in the fields of the web form.

### PRIORITY CLAIM

This patent application claims priority from:
(1) U.S. Provisional patent application No. 61/671,207, titled ‘Method and system for securely populating data in web forms’ filed on Jul. 13, 2012; and
(2) Australian patent application no. 2012903777, titled ‘Method and system for securely populating data in web forms’ filed on Aug. 31, 2012.

### FIELD OF TECHNOLOGY

The present disclosure generally relates to secured communication of personal information, and more particularly relates to a field of auto-completion of web forms.

### BACKGROUND

With the increased use of World Wide Web, many online activities such as online shopping, registering at a website, making online application, applying for a loan, ticket booking, bill payments, etc are performed on daily basis which require filling of web forms. A web form is a web page enabling a user to enter data in plurality of fields which is either processed by a server or stored in a database. Typically, the plurality of fields includes text boxes, drop boxes, radio buttons, check boxes, file selection boxes, password entry boxes and so on.

Many a times, the information required to be filled in the web form is redundant with information already entered into another web form, application, or a system. Further, the user has to manually fill redundant information in the fields to complete the web form. This, becomes a cumbersome exercise and results in wastage of time. Hence, in order to facilitate easy filing of web forms, auto form filling algorithm were developed and provided to web users. Generally, auto form filling algorithm records information that has been previously filled by the user in similar fields in a user profile stored in a remote server. The information that is being stored in the remote server sometimes includes sensitive information (e.g., credit card information, signature, password, phone number, email ID, bank account number, etc.) of the user. The user has no control over the sensitive information that was intentionally or unintentionally stored in the remote server and hence there exist a high risk of sensitive information being misused by a third party or other web users.

### SUMMARY OF THE INVENTION

A method and system for secured communication of personal information is disclosed. In one aspect, a method of managing personal information in a computing environment may include receiving an unique code from a computing device, validating the unique code received from the computing device, and dynamically obtaining personal information from the computing device if the unique code is successfully validated.

In another aspect, a method of securely populating information in a web form may include receiving a request for unique code from a computing device, and providing the unique code to the computing device in response to the received request. The method may further include receiving a unique code from another computing device, dynamically obtaining personal information corresponding to data fields in a web form displayed on the computing device from the said another computing device if the unique code provided to the computing device matches with the unique code received from said another computing device, and populating the personal information in the corresponding data fields of the web form.

In yet another aspect, a method of securely storing information filled in a web form on a computing device may include receiving a request for unique code from a computing device, and providing the unique code to the computing device in response to the received request. The method may further include receiving a unique code from another computing device, obtaining personal information filled in data fields of a web form displayed on the another computing device if the unique code provided to the computing device matches with the unique code received from said another computing device, and providing the obtained personal information to the computing device.

In a further aspect, the invention may provide an apparatus including a processor, and a memory coupled to the processor. The memory may include an executable program stored in the form of instructions, which when executed by the processor, causes the processor to perform the methods described above.

In yet a further aspect, there may be provided a non-transitory computer-readable storage medium having instructions stored therein, which when executed by a processor, causes the processor to perform the methods described above.

Other features of the embodiments will be apparent from the accompanying drawings and from the detailed description that follows.

### BRIEF DESCRIPTION OF THE VIEWS OF DRAWINGS

FIG. 1 is a block diagram illustrating an exemplary system for securely populating personal information in web forms, according to one embodiment.

FIG. 2 is a screenshot view depicting a populate button integrated in a rendered output of a website displayed in a web browser, according to one embodiment.

FIG. 3 is a screenshot view depicting a unique code displayed in the web browser, according to one embodiment.

FIG. 4 is a screenshot view depicting a mobile device with a populate web form application, according to one embodiment.

FIG. 5 is a screenshot view depicting the web browser in which the web form is populated with the personal information, according to one embodiment.

FIG. 6 is a process flowchart illustrating an exemplary method of populating personal information in a web form, according to one embodiment.

FIG. 7 is a block diagram illustrating an exemplary system for securely populating personal information in web forms, according to another embodiment.

FIG. 8 is a screenshot view depicting a mobile device with a graphical user interface displaying a populate button, according to another embodiment.

FIG. 9 is a screenshot view depicting a mobile device displaying a unique code, according to one embodiment.

FIG. 10 is a screenshot view depicting an auto data storage module integrated in the website displayed in the web browser, according to one embodiment.

FIG. 11 is a process flowchart illustrating an exemplary method of storing personal information filled in a web form into a first computing device, according to one embodiment.

FIG. 12 is a block diagram illustrating an exemplary system for securely sharing personal information with a third party system, according to yet another embodiment.

FIG. 13 is a process flowchart illustrating an exemplary method of generating and providing a unique code to the third party system, according to one embodiment.

FIG. 14 is a process flowchart illustrating an exemplary method of sharing personal information using the unique code, according to one embodiment.

FIG. 15 is a diagrammatic system view of a data processing system 1500 in which any of the embodiments disclosed herein may be performed, according to one embodiment.

Other features of the embodiments will be apparent from the accompanying drawings and from the description that follows.

### DETAILED DESCRIPTION

A method and system for secured communication of personal information is disclosed. In the following description, for the purposes of explanation, numerous specific details are set forth in order to provide a thorough understanding of the various embodiments. It will be evident, however to one skilled in the art that the various embodiments may be practiced without these specific details. It should be noted in the following description that, like or the same reference numerals in different embodiments denote the same or similar features.

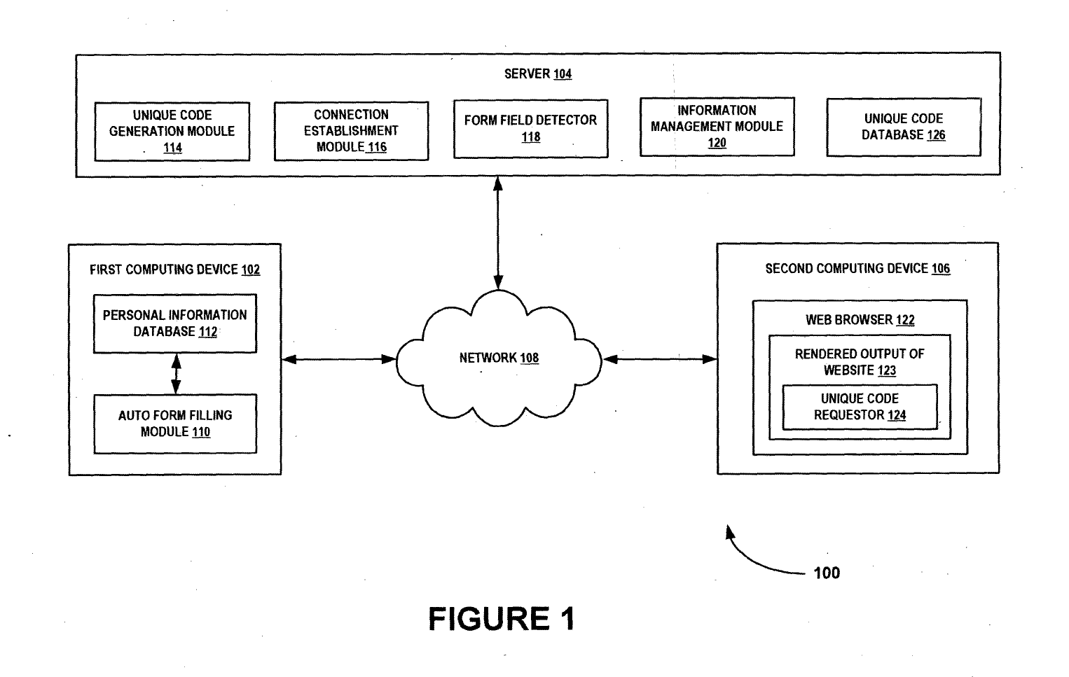

FIG. 1 is a block diagram illustrating an exemplary system 100 for securely populating personal information in web forms, according to one embodiment. In FIG. 1, the system 100 includes a first computing device 102, a server 104 and a second computing device 106. The first computing device 102 may be smart phone, personal digital assistant and like devices. The second computing device 106 may be a desktop, a laptop, a tablet computer and the like devices. The server may be a web server, an application server, and the like. The first computing device 102 and the second computing device 106 are remotely connected to the server 104 via a network 108 (e.g., local area network, wide area network, etc.).

The first computing device 102 includes an auto form filling module 110 and a personal information database 112. The server 104 includes a unique code generation module 114, a connection establishment module 116, a form field detector 118, an information management module 120, and a unique code database 126. The second computing device 106 includes a web browser 122 displaying a website 123 which integrates a unique code requestor 124.

When a user of the second computing device 106 opens a website 123 containing a web form (e.g., a hypertext markup language (HTML) form) in the web browser 122, the unique code requestor 126 integrated into the rendered output of the website 123 enables the user to instantly populate personal information stored in the first computing device 102 in appropriate data fields in the web form. Exemplary personal information associated with the user may include name, address, contact information, bank account information, credit card information, and so on. In an exemplary operation, when the user clicks on a populate button integrated into the rendered output of the website 123, the unique code requestor 124 sends a request for generating a unique code to the server 104 via the network 108.

The unique code generation module 114 generates a unique code based on the request received from the unique code requestor 102. Fox example, the unique code are composed of six character alpha string. Among the six characters, first five characters of the string are randomly selected from alphabets A-Z and the sixth character is based on a geographic location of the server 104. Each of geographic regions is assigned a unique subset of alpha characters from the alphabets A-Z. For example, a server in the Australian region may be assigned alpha characters [A B C] while a server in the US region may be assigned alpha characters [D E F]. The subset of alpha characters uniquely assigned to each geographic region is stored in a shared table. Thus, the value of sixth character corresponding to a geographic region is determined using the shared table. Additionally, the server in each geographic region maintains unique codes generated for assignment over a period of time along with direction of data flow, server unique resource identifier (URI) and a form identifier or a user identifier in a unique code database 126. It is understood that the unique code may be generated using various code generation techniques well known to the person skilled in the art.

Thereafter, the unique code generation module 114 sends the generated unique code to the second computing device 106. Accordingly, the second computing device 106 displays the unique code in the rendered output of the website 123.

The first computing device 102 is configured for receiving the unique code inputted by the user via a graphical user interface (not shown). In one embodiment, the auto form filling module 110 in the first computing device 102 enables the user to input the unique code via the graphical user interface. Upon receiving the unique code, the auto form filling module 110 communicates the unique code to the server 104 via the network 108.

The connection establishment module 116 validates the unique code received from the first computing device 102. In some embodiments, the connection establishment module 116 compares the unique code provided to the second computing device 106 and the unique code received from the first computing device 102. In these embodiments, the connection establishment module 116 determines the unique code received from the first computing device 102 as successfully validated if the unique code received from the first computing device 102 matches with the unique code provided to the second computing device 106. Further, the connection establishment module 116 identifies connections established with the first computing device 102 and the second computing device 106 based on the validated unique code. In some embodiments, the connection establishment module 116 identifies port numbers associated with the connections established with the first computing device 102 and the second computing device 106 based on the unique code provided to the second computing device 106 and received from the first computing device 102.

Thereafter, the field detector module 118 identifies the data fields in the web form based on metadata associated with the data fields. Then, the information management module 120 securely fetches personal information corresponding to data fields of the web form from the personal information database 112. Then, the information management module 120 populates the fetched personal information in the appropriate data fields of the web form. In some instances, the user may wish not to provide sensitive information such as email address, password, credit card information in every web form visited by the user. In such a case, the information management module 120 prompts the first computing device 102 as whether certain kind of information is to be populated in corresponding fields of the online web form. Upon receiving approval from the first computing device 102, the information management module 120 fetches the information from the personal information database 112 and populates the fetched information in the appropriate data fields of the web form. Accordingly, the information populated in the data fields is posted to the server 104 for processing and persistence.

In accordance with the foregoing description, in one embodiment, the auto form filling module 110 enables a user to sign a document through providing a signing screen. The user can sign the document using finger on the signing screen. The auto form filling module 110 records the signature image drawn on the signing screen, and Internet Protocol (IP) address and location of the first computing device 102 and sends the document with the signature image, the IP address and the location to the server 104. This can also be implemented where multiple users need to sign the document.

In another embodiment, the auto form filling module 110 enables a user to sign an online (or ‘card not present’) payment. When the credit card details are required, the user is enabled to enter the unique code received from the server 104 and sign on the signing screen displayed on the first computing device 102 using his finger. Accordingly, the first computing device 102 sends the signature image, IP address and location along with credit card details to the server 104 for making online payments.

In yet another embodiment, the auto form filling module 110 enables a user to share a business card. The user can capture a photograph of a business card and store the image in the first computing device 102. Also, the user can enter corresponding details such as Business Name, Phone number, and email address. When a card is to be shared, the user can enter email address of a person with whom the card is to be shared and accordingly the auto form filling module 110 sends the business card along with corresponding details to the email ID.

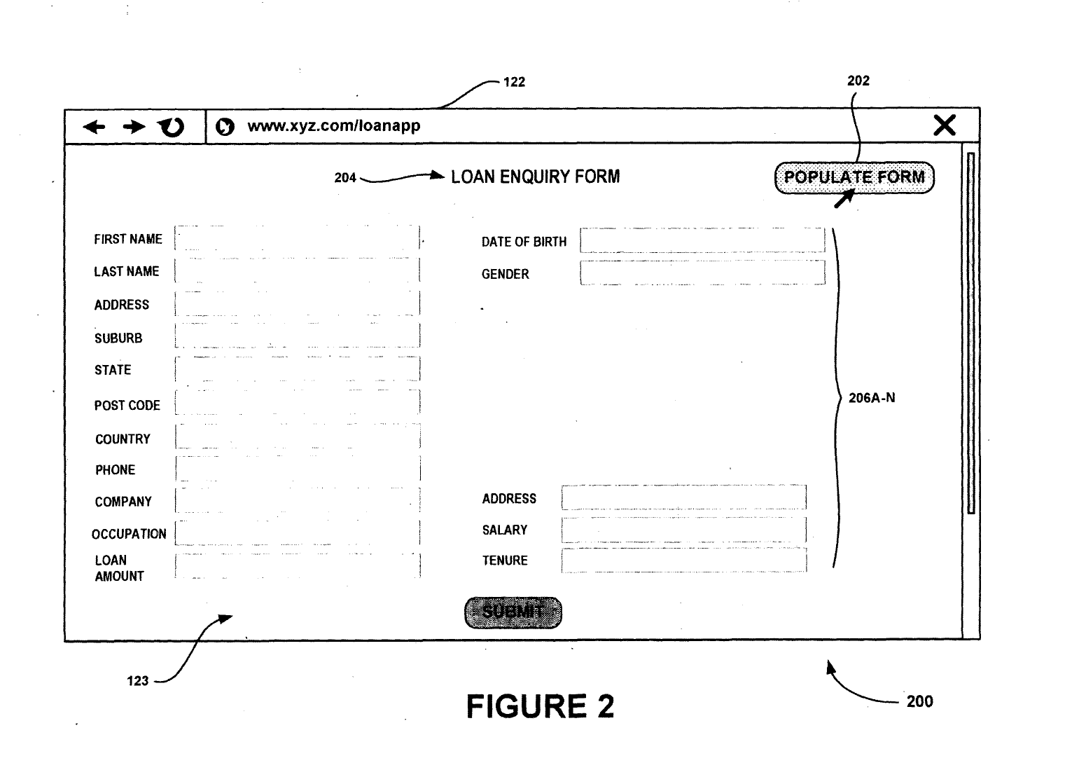

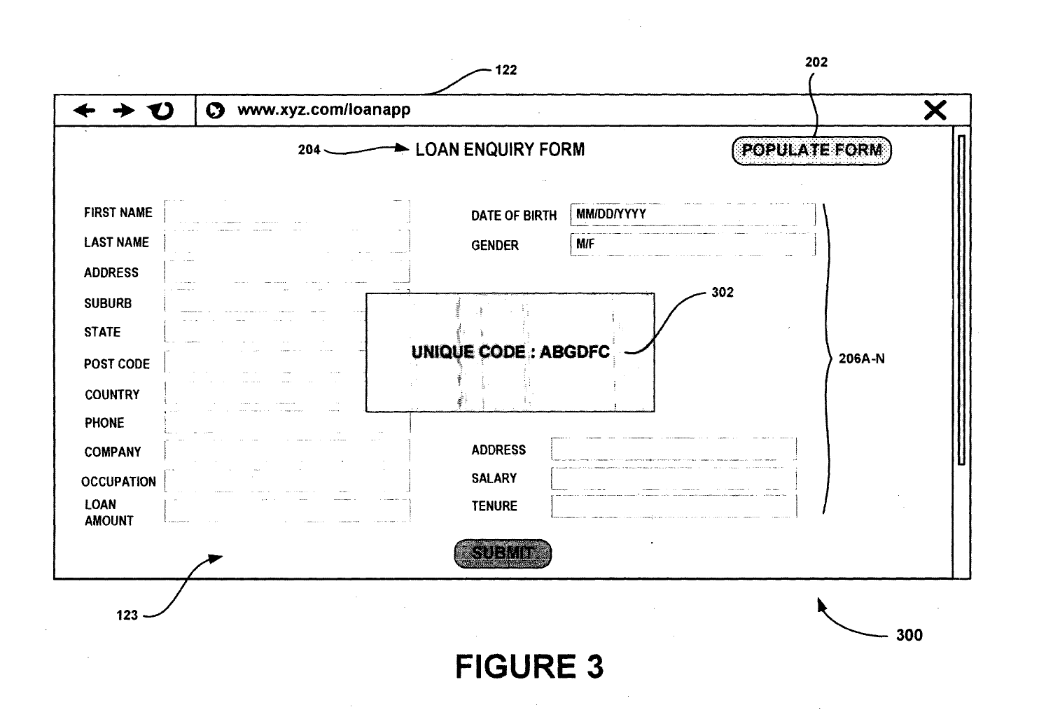

FIG. 2 is a screenshot view 200 depicting a populate button 202 integrated in a rendered output of a website 123 displayed in the web browser 122, according to one embodiment. The web browser 122 displays a rendered output of a website 123. As shown, the rendered output of the website 123 includes a web form 204 containing plurality of data fields 206A-N, along with the integrated populate button 202. In one exemplary implementation, the populate button 202 is a widget installed on the website 123 (e.g., webpage containing the web form 204) displayed in the web browser 122 for facilitating the user to instantly populate information in the web form 204 associated with the website 123. In one embodiment, the populate button 202 is configured for performing the functionality of the unique code requestor 124 as described above. For example, when a user wishes to instantly populate the web form 204, the user clicks the populate button 202 displayed in the web browser 122 which in turn triggers a request for unique code to the server 104. In response, the server 104 provides a unique code 302 which is displayed in the display area of the web browser 122 as shown in FIG. 3. As depicted, the unique code 302 contains six characters “ABGDFC” in which the first five characters are randomly selected and the sixth character corresponds to the geographic region to which the server 104 belongs to.

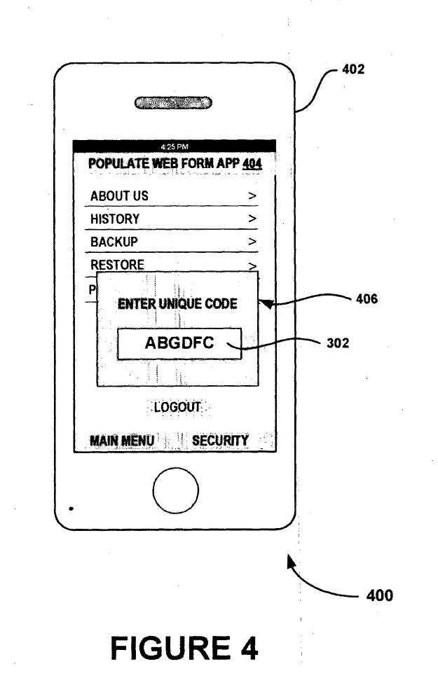

FIG. 4 is a screenshot view 400 depicting a mobile device 402 with a populate web form application 404, according to one embodiment. It is appreciated that the mobile device 402 is an exemplary embodiment of the first computing device 102 of FIG. 1. Also, the populate form application 404 is an exemplary embodiment of the auto form filling module 110 of FIG. 1.

When the unique code 302 is displayed in the web browser 122, the populate form application 404 enables the user to enter the unique code in the graphical user interface 406 of the mobile device 402. The populate form application 404 communicates the unique code 302 to the server 104. The server 104 validates the unique code 302 and establishes a connection between the mobile device 402 and the web browser 122 if the unique code 302 is successfully validated.

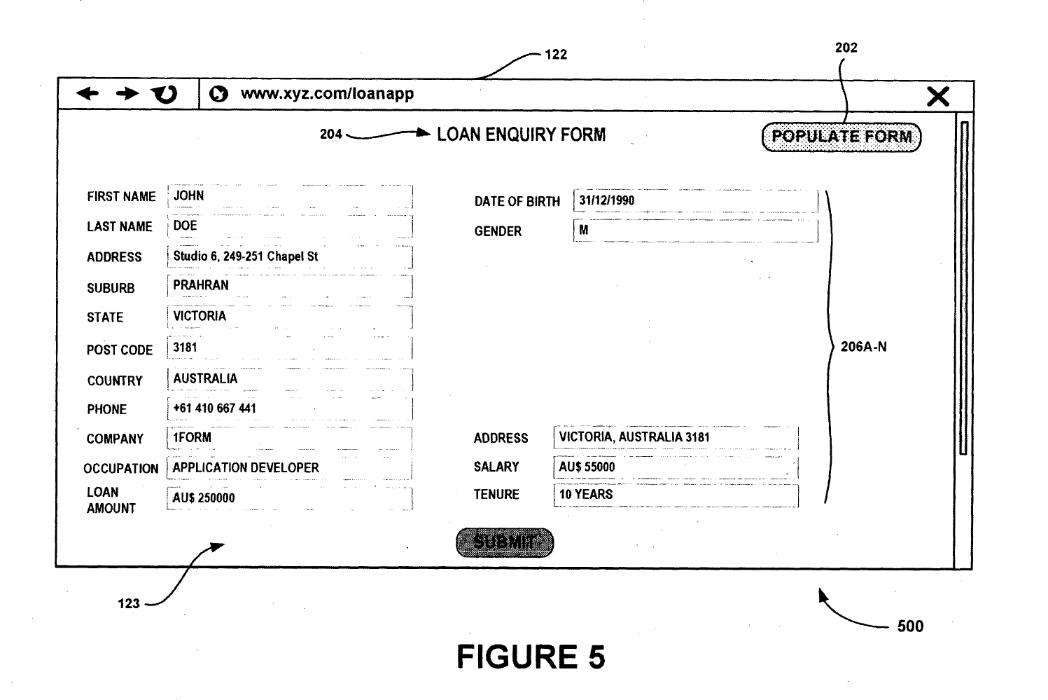

FIG. 5 is a screenshot view 500 depicting the web browser 122 in which the web form 204 is populated with the personal information, according to one embodiment. The web browser 122 displays the web form 204 whose data fields are populated with the personal information retrieved from the mobile phone 402 upon establishment of secured connection. The information populated in the data fields is then posted to the server 104 for processing and persistence. In this manner, the web form 204 can be instantly and securely populated.

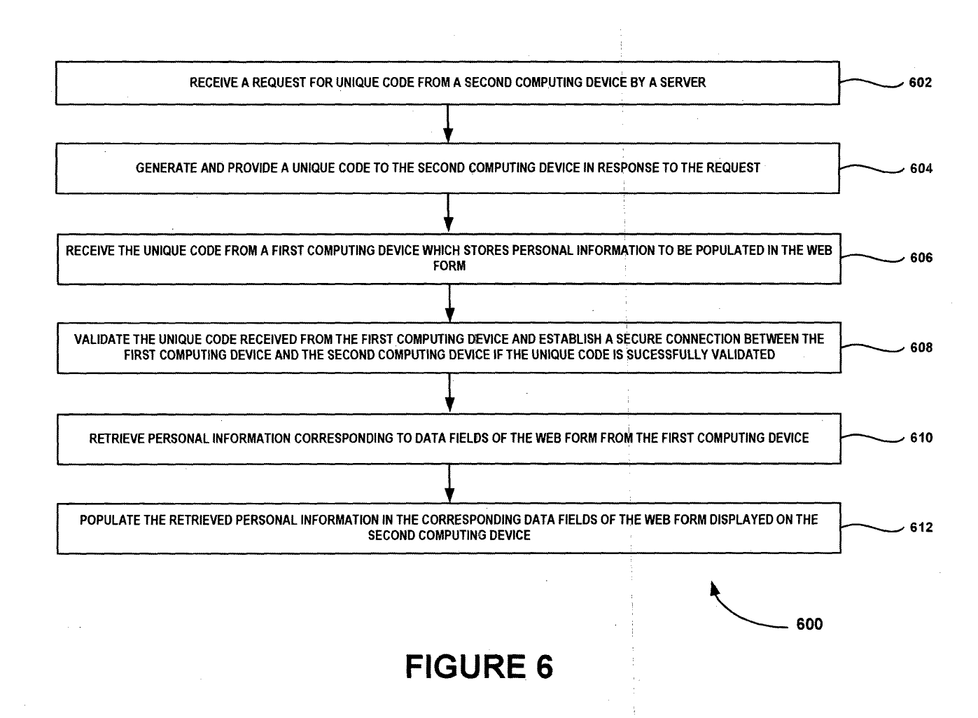

FIG. 6 is a process flowchart 600 illustrating an exemplary method of populating personal information in a web form, according to one embodiment. At step 602, a request for unique code is received from the second computing device 106 by the server 104. At step 604, a unique code is generated and provided to the second computing device 106 in response to the request.

At step 606, the unique code is received from the first computing device 102 which stores personal information to be populated in a web form displayed on the second computing device 106. At step 608, the unique code received from the first computing device 102 is validated and a secure connection is established between the first computing device 102 and the second computing device 106 if the unique code is successfully validated. At step 610, personal information corresponding to data fields of the web form is retrieved from the first computing device 102. At step 612, the retrieved personal information is instantly populated in the corresponding data fields of the web form displayed on the second computing device 106.

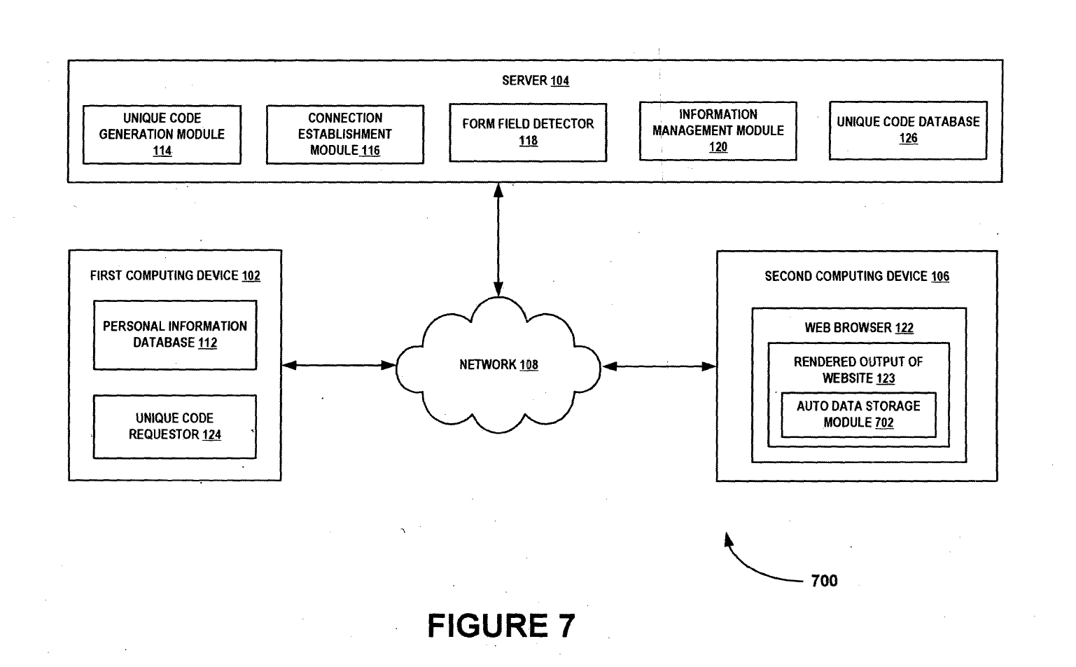

FIG. 7 is a block diagram illustrating an exemplary system 700 for securely populating personal information in web forms, according to another embodiment. The first computing device 102 includes a unique code requester 124, and a personal information database 112. The server 104 includes a unique code generation module 114, a connection establishment module 116, a form field detector 118, and an information management module 120. The second computing device 106 includes a web browser 122 displaying a website 123 which integrates an auto data storage module 702.

Consider that a user fills personal information in data fields of the web form displayed in the web browser 122. Suppose, the user wishes to store information filled in data fields of the web form in the personal information database 112. In such case, the unique code requestor 126 in the first computing device 102 enables the user to store the personal information filled in the data fields of the web form in the personal information database 112. In an exemplary operation, the unique code requestor 124 sends a request for generating a unique code to the server 104 via the network 108.

The unique code generation module 114 generates a unique code based on the request received from the unique code requestor 102. Further, the unique code generation module 114 sends the generated unique code to the first computing device 102. Accordingly, the first computing device 102 displays the unique code via a graphical user interface (not shown).

The second computing device 106 is configured for receiving the unique code inputted by the user via the web site 123. In one embodiment, the auto data storage module 702 in the second computing device 106 enables the user to input the unique code in unique code field of the web site 123. Upon receiving the unique code, the auto data storage module 702 communicates the unique code to the server 104 via the network 108.

The connection establishment module 116 validates the unique code received from the second computing device 106. In some embodiments, the connection establishment module 116 compares the unique code provided to the first computing device 102 and the unique code received from the second computing device 106. In these embodiments, the connection establishment module 116 determines the unique code received from the second computing device 106 as successfully validated if the unique code received from the second computing device 106 matches with the unique code provided to the first computing device 102. Further, the connection establishment module 116 establishes a secured connection between the first computing device 102 and the second computing device 106 if the unique code is successfully validated.

Thereafter, the field detector module 118 identifies the data fields in the web form. Then, the information management module 120 securely fetches the personal information from the data fields of the web form. Accordingly, the information management module 120 stores the fetched personal information from the data fields of the web form in the personal information database 112. One skilled in the art will understand that the personal information stored in the personal information database 122 is used for populating participating web forms instantly as described in FIGS. 1 to 6 or sharing with a third party to avail offers. Although, FIG. 7 illustrates storing of information filled in data fields of web form displayed on the second computing device 106, one can envision that the present invention can also applicable for storing information filled in data fields of web form displayed in the first computing device 102 in the personal information database 112 of the first computing device 102.

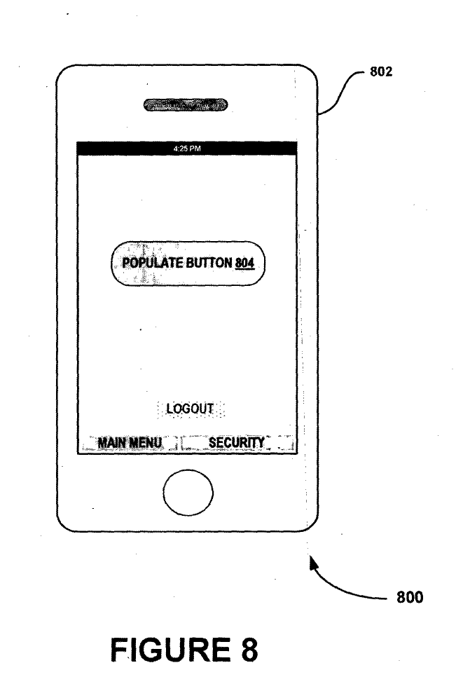

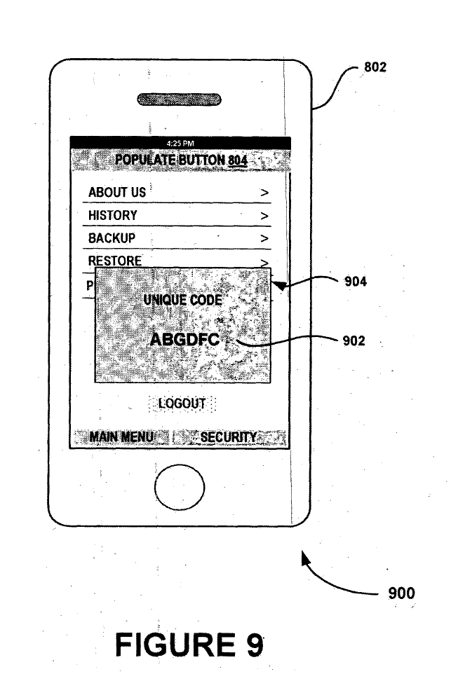

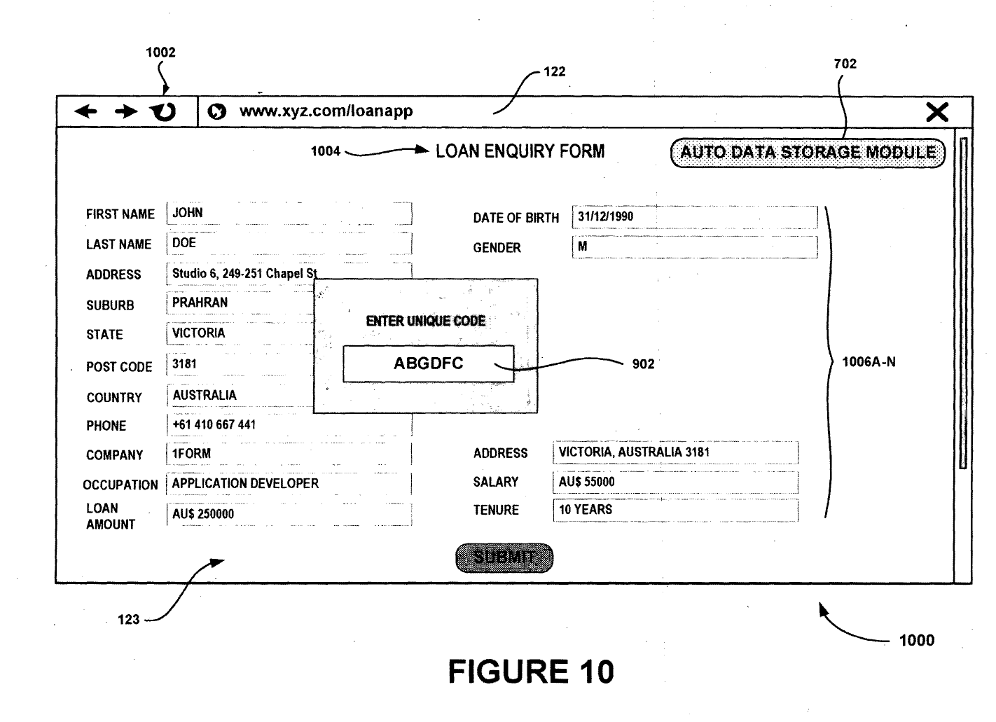

FIG. 8 is a screenshot view 800 depicting a mobile device 802 with a graphical user interface displaying a populate button 804, according to another embodiment. It is appreciated that the mobile device 802 is an exemplary embodiment of the first computing device 102 of FIG. 1. In one embodiment, the populate button 804 is configured for performing the functionality of the unique code requestor 124 as described in FIG. 7. For example, when a user wishes to instantly store personal information filled in data fields of a web form displayed in a web browser of another device as shown in FIG. 10, the user clicks the populate button 804 which results in triggering of a request for unique code to the server 104. In response, the server 104 generates and provides a unique code 902 which is displayed in the graphical user interface 904 of the mobile device 802 as shown in FIG. 9.

FIG. 10 is a screenshot view 1000 depicting an auto data storage module 702 integrated in the website 123 displayed in the web browser 122, according to one embodiment. As shown, the web browser 122 displays a rendered output of the website 123 on a display of a laptop computer 1002. As shown, the rendered output of the website 123 includes a web form 1004 containing a plurality of data fields 1006A-N and the auto data storage module 702. In one exemplary implementation, the auto data storage module 702 is a plug-in integrated in the website 123 displayed in the web browser 122 for facilitating the user to instantly store personal information filled in the web form 204 associated with the website 123.

When the unique code 902 is displayed in the mobile device 802, the auto data storage module 702 enables the user to enter the unique code in the website 123 of the laptop computer 1002. Once the unique code is inputted, the auto data storage module 702 communicates the unique code 902 to the server 104. The server 104 validates the unique code 902 and establishes a secured connection between the mobile device 802 and the laptop computer 1002 if the unique code 902 is successfully validated. Further, the server 104 fetches the information filled in the data fields 1006A-N of the web form 1004 and stores the personal information in the mobile device 802.

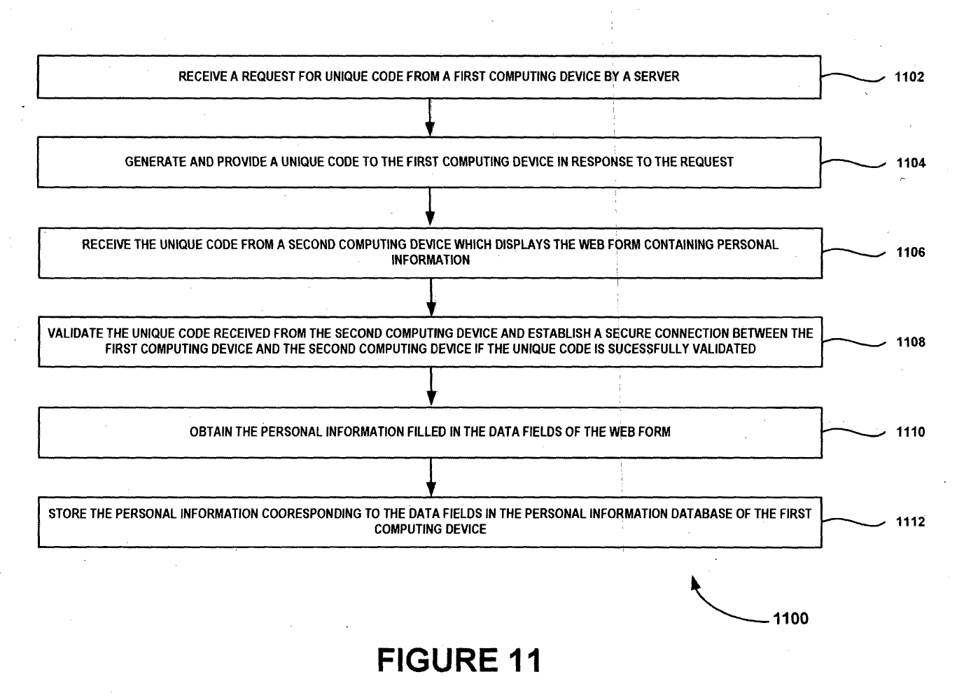

FIG. 11 is a process flowchart 1100 illustrating an exemplary method of storing personal information filled in a web form in the first computing device 102, according to one embodiment. At step 1102, a request for unique code is received from the first computing device 102 by the server 104. At step 1104, a unique code is generated and provided to the first computing device 102 in response to the request.

At step 1106, the unique code is received from the second computing device 106 which displays the web form containing personal information. At step 1108, the unique code received from the second computing device 106 is validated and a secure connection is established between the first computing device 102 and the second computing device 106 if the unique code is successfully validated. At step 1110, personal information filled in data fields of the web form is obtained. At step 1112, the personal information corresponding to the data fields in the web form is instantly stored in the personal information database 112 of the first computing device 102.

One skilled in the art will understand that the personal information database 112 in the first computing device 102 is continuously built over a period of time. When the user registers for the auto form filling service for the first time, the information management module 120 collects personal information associated with the user in a profile form, and stores the collected personal information in the personal information database 112 in the first computing device 102. If the user wishes to exit by abandoning the partially filled profile form, the information management module 120 encrypts and stores the information entered in the partially filled profile form in the personal information database 112. Furthermore, the information management module 120 allows the user to complete/edit the personal information stored in the personal information database 112.

Additionally, during filling the profile form, the information management module 120 enables the user to mark one or more fields in the profile form that contain sensitive information (such as email, password, phone number, credit card number, salary, etc.) for security alerts. The information management module 120 tags the fields for security alerts and the prompts the user prior to populating information in such fields during auto filling process.

Also, when auto filling the web form, the form field detector 118 identifies one or more fields in the web form for which the information is not present in the personal information database 112. Accordingly, the information management module 120 collects the information manually fed by the user in the corresponding fields of the web form and stores the collected information corresponding to the identified fields in the personal information database 112. Moreover, the information management module 120 updates the personal information database 112 when different information, as compared to the stored information, corresponding to the same field is filled by the user.

Further, the information management module 120 stores a history of forms and the associated fields which were populated using auto fill option in the first computing device 102. The auto form filling module 110 in the first computing device 102 may display the history of the visited web forms and associated fields which were populated in the past using information in the personal information database 112. The auto form filling module 110 also enables the user to clear the history stored in the first computing device 102.

Furthermore, the information management module 120 enables the user to remotely delete/back up the information stored in the personal information database 112 if the first computing device 102 is lost. The information management module 120 enables the user to back up the information stored in the personal information database 112 to a file (stored locally or on the server) and later restore the backed-up personal information using the back-Up file.

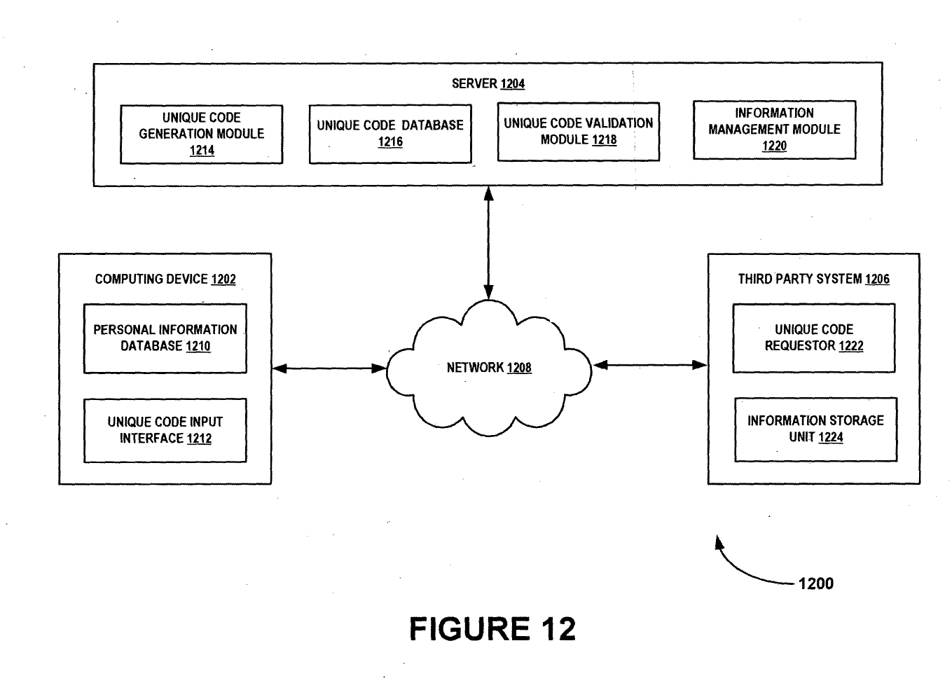

FIG. 12 is a block diagram illustrating an exemplary system 1200 for securely sharing personal information with third party system, according to yet another embodiment. In FIG. 12, the system 1200 includes a computing device 1202, a server 1204, and a third party system 1206. The computing device 1202 may be a mobile phone, a smart phone, a tablet, a laptop computer and the like devices. The third party system 1206 may be a computer, a group of computers, a server and so on. The server 1204 is communicatively coupled to the computing device 1202 and the third party system 1206 via a wireless network 1208.

The computing device 1202 includes a personal information database 1210 and a unique code input interface 1212. The personal information database 1210 stores personal information of a user of the computing device 1202 such as name, address, contact information, educational details, professional details, bank account details, credit card information and so on.

The server 1204 includes a unique code generation module 1214, a unique code database 1216, a unique code validation module 1218, and an information management module 1220. The third party system 1206 includes an unique code input requestor 1222, and an information storage unit 1224.

In an exemplary operation, the unique code requestor 1222 requests an unique code with the server 1204. The unique code generation unit 1214 generates an unique code based on the request from the third party system 1206. The unique code may be sequence of numbers characters, web address and so on. The unique code may be valid for a pre-determined period of time. The validity is defined by the third party system 1206. Alternatively, the validity of the unique code is defined by the unique code generation unit 1214. In some embodiments, the unique code generation unit 1214 may select a unique code from the unique code database 1216 which stores a plurality of unique codes and provides the selected unique code to the third party system 1206.

Upon receiving the unique code from the server 1204, the third party system 1206 publishes a unique code in a brochure, advertisement, website or any other means availing an offer. When the user wishes avail an offer availed by the third party, the unique code input interface 1212 allows the user to input the unique code associated with the offer. Upon inputting the unique code via the unique code input interface 1212, the computing device 1202 sends the unique code to the server 1204. Thereafter, the unique code validation module 1218 validates the unique code received from the computing device 1202. In some embodiments, the unique code validation module 1218 validates the unique code based on life of the unique code. If the unique code is successful validated, the information management module 1220 obtains, personal information required for availing the offer from the personal information database 1210 of the computing device 1202. Further, the information management module 1220 sends the personal information obtained from the personal information database 1210 to the third party system 1206 which stores the received information in the information storage unit 1224 for further processing.

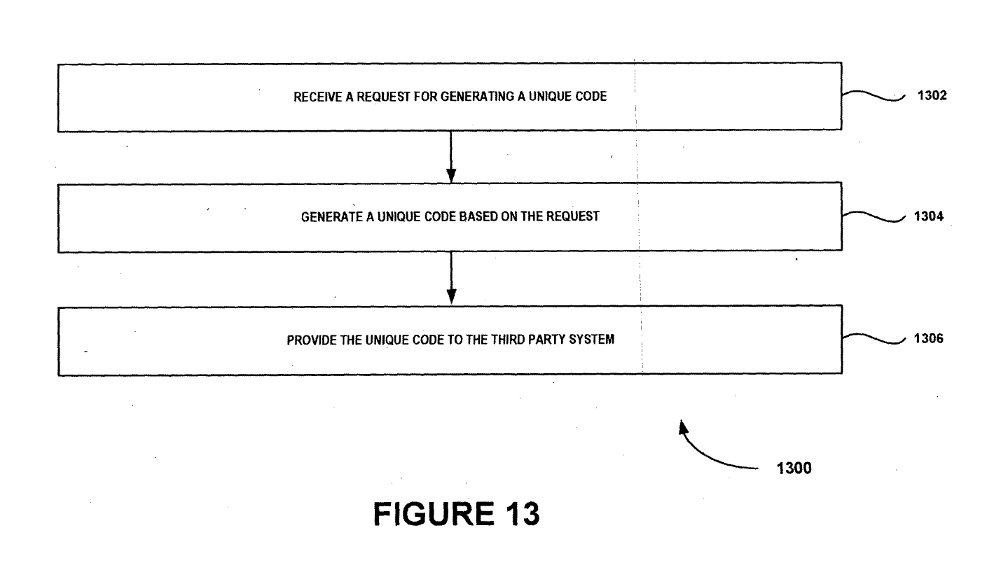

FIG. 13 is a process flowchart 1300 illustrating an exemplary method of generating and providing unique code to the third party system 1206, according to one embodiment. At step 1302, a request for generating a unique code is received from third party system 1206. At step 1304, a unique code is generated by the server 1204 based on the request from the third party system 1206. At step 1306, the unique code is provided to the third party system 1206. In an exemplary implementation, the third party system 1206 may publish the unique code with offers availed to public. The unique code may facilitate the third party system 1206 to obtain personal information stored in the computing device 1202 via the server 1204 when the user of the computing device 1202 wishes to avail one or more offers.

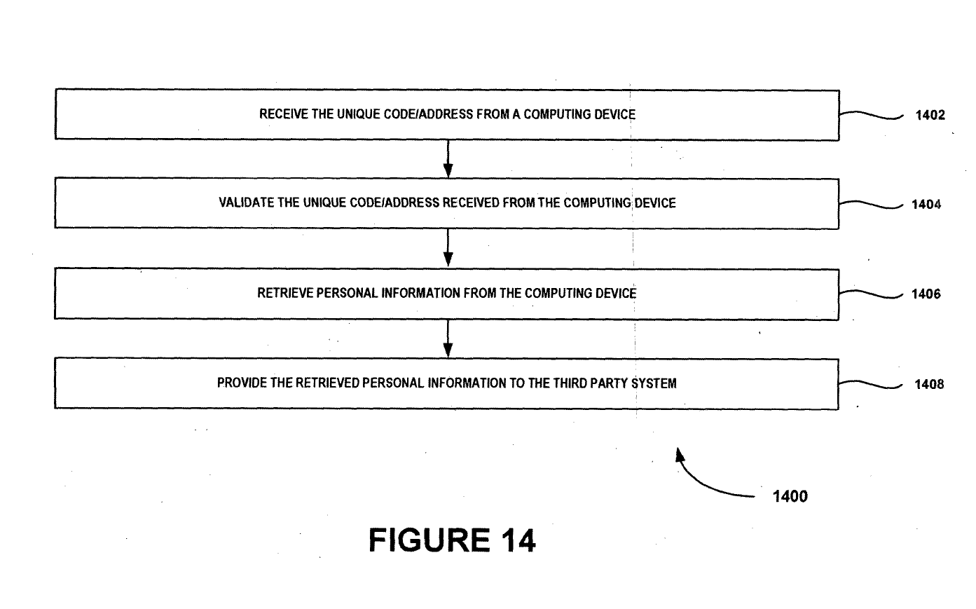

FIG. 14 is a process flowchart 1400 illustrating an exemplary method of sharing personal information using the unique code, according to one embodiment. At step 1402, the unique code is received from the computing device 1202. At step 1404, the unique code received from the computing device 1202 is validated. At step 1406, personal information is retrieved from the computing device 1202 if the unique code successfully validated. At step 1408, the retrieved personal information is provided to the third party system 1206 associated with the unique code.

In alternate embodiment, a third party agent (e.g., a customer care representative/insurance agent) may generate a unique code using the unique code requestor 1224 and provide the unique code to the user of the computing device 1202 over telephone. When the computing device 1202 receives the unique code inputted by the user, the computing device 1202 communicates the unique code with the server 1204. Accordingly, the server 1204 establishes a secured connection upon successful validation of the unique code. Upon connection establishment, the server 1204 retrieves desired personal information of the user from the personal information database 1210 and provides the personal information to the third party system 1206. For example, the personal information may help the third party agent verify identity of user to determine whether they are talking the correct person. Similarly, the user can also verify the identity of the third party by entering the unique code provided by the third party agent in the unique code input interface 1212 associated with the computing device 1202.

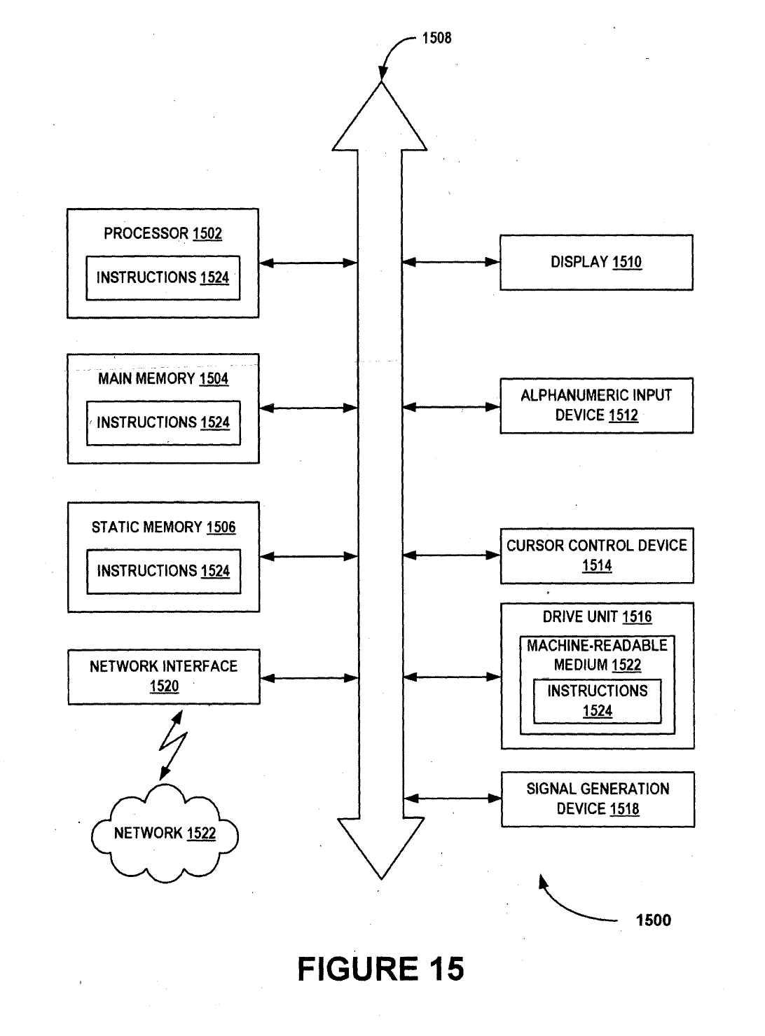

FIG. 15 is a diagrammatic system view of a data processing system 1500 in which any of the embodiments disclosed herein may be performed, according to one embodiment. The data processing system 1500 is an exemplary embodiment of the first computing device 102, the server 104, the second computing device 106, the computing device 1202, the server 1204, and the third party system 1206 of FIGS. 1, 7 and 12. Particularly, the diagrammatic system view 1500 of FIG. 15 illustrates a processor 1502, a main memory 1504, a static memory 1506, a bus 1508, a display 1510, an alpha-numeric input device 1512, a cursor control device 1514, a drive unit 1516, a signal generation device 1518, a network interface device 1520, a machine readable medium 1522, instructions 1524, and a network 1526.

The diagrammatic system view 1500 may indicate a personal computer and/or a data processing system in which one or more operations disclosed herein are performed. The processor 1502 may be a microprocessor, a state machine, an application specific integrated circuit, a field programmable gate array, etc. (e.g., Intel® Pentium® processor). The main memory 1504 may be a dynamic random access memory and/or a primary memory of a computer system. The static memory 1506 may be a hard drive, a flash drive, and/or other memory information associated with the data processing system 700. The bus 1508 may be an interconnection between various circuits and/or structures of the data processing system 700. The display 1510 may provide graphical representation of information on the data processing system 700. The alpha-numeric input device 1512 may be a keypad, keyboard and/or any other input device of text (e.g., a special device to aid the physically handicapped). The cursor control device 1514 may be a pointing device such as a mouse.

The drive unit 1516 may be a hard drive, a storage system, and/or other longer term storage subsystem. The signal generation device 1518 may be a bios and/or a functional operating system of the data processing system 700. The network interface device 1520 may be a device that may perform interface functions such as code conversion, protocol conversion and/or buffering required for communication to and from the network 1526. It is appreciated that the network 1526 is an exemplary embodiment of the network 108 and 1208. The machine readable medium 1522 may provide instructions on which any of the methods disclosed herein may be performed. The instructions 1524 may provide source code and/or data code to the processor 1502 to enable any one/or more operations disclosed herein. For example, the instructions may be capable of performing the functionality of various modules illustrated in FIGS. 1, 7, and 15 when executed by the processor 1502.

### Interpretation

### Wireless:

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes:

Unless specifically stated otherwise, as apparent from the following discussions, it is appreciated that throughout the specification discussions utilizing terms such as “processing”, “computing”, “identifying”, “determining”, “selecting” or the like, refer to the action and/or processes of a computer or computing system, or similar electronic computing device, that manipulate and/or transform data represented as physical, such as electronic, quantities into other data similarly represented as physical quantities.

### Processor:

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium:

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors:

In alternative embodiments, the one or more processors operate as a standalone device or may be connected, e.g., networked to other processor(s), in a networked deployment, the one or more processors may operate in the capacity of a server or a client machine in a server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments:

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement the method steps described herein. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means For Carrying out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of the device A and an input of the device B which may be a path including other devices or means. “Connected” may mean that two or more elements are either in direct physical or electrical contact, or that two or more elements are not in direct contact with each other but yet still co-operate or interact with each other.

### Embodiments:

Reference throughout this specification to “one embodiment” or “an embodiment” means that' a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose.

### Different Instances of Objects

As used herein, unless otherwise specified the use of the ordinal adjectives “first”, “second”, “third”, “another”, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention.

Any one of the terms including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the software industry.

1. A method of managing personal information in a computing environment, comprising:
receiving an unique code from a computing device;
validating the unique code received from the computing device; and
dynamically obtaining personal information from the computing device if the unique code is successfully validated.

2. The method of claim 1, further comprising:
receiving a request for an unique code for obtaining personal information from another computing device;
generating the unique code based on the request; and
providing the generated unique code to the user of said another computing device.

3. The method of claim 1, wherein validating the unique code received from the computing device comprises:
comparing the received unique code with the generated unique code; and
validating the received unique code based on the outcome of comparison.

4. The method of claim 1, wherein dynamically obtaining the personal information stored in the computing device if the unique code is successfully validated comprises:
dynamically obtaining personal information corresponding to data fields of a web form displayed on said another computing device from the computing device if the unique code received from the computing device is successfully validated; and
populating the personal information obtained from the computing device into the corresponding data fields of the web form.

5. The method of claim 1, wherein dynamically obtaining the personal information stored in the computing device if the unique code is successfully validated comprises:
dynamically obtaining personal information filled in one or more data fields of a web form displayed on the computing device if the unique code received from the computing device is successfully validated;
storing the personal information filled in the one or more data fields of the web form on another computing device.

6. The method of claim 1, wherein dynamically obtaining the personal information from the computing device if the unique code is successfully validated comprises:
dynamically obtaining personal information from the computing device if the unique code
received from the computing device is successfully validated; and
providing the obtained personal information to a third party system.

7. The method of claim 1, further comprising:
creating a backup of the personal information stored in the computing device.

8. The method of claim 7, further comprising:
restoring the backed up personal information in the computing device.

9. An apparatus comprising:
a processor; and
a memory coupled to the processor, wherein the memory comprises an executable program stored in the form of instructions, which when executed by the processor, cause the processor to perform following steps comprising:
validating a unique code received from a computing device; and
dynamically obtain personal information from the computing device if the unique code is successfully validated.

10. The apparatus of claim 9, wherein the executable program cause the processor to perform following steps comprising:
generating the unique code based on a request received from another computing device; and
providing the generated unique code to the user of said another computing device.

11. The apparatus of claim 9, wherein in validating the unique code received from the computing device, the executable program cause the processor to perform following steps comprising:
comparing the received unique code with the generated unique code; and
validating the received unique code based on the outcome of comparison.

12. The apparatus of claim 9, wherein the executable program cause the processor to perform following steps comprising:
creating a backup of the personal information stored in the computing device; and
restoring the backed up personal information in the computing device.

13. A method of securely populating information in a web form, comprising:
receiving a request for unique code from a computing device;
providing the unique code to the computing device in response to the received request;
receiving a unique code from another computing device;
dynamically obtaining personal information corresponding to data fields in a web form displayed on the computing device from the said another computing device if the unique code provided to the computing device matches with the unique code received from said another computing device; and
populating the personal information in the corresponding data fields of the web form.

14. The method of claim 13, wherein obtaining the personal information corresponding to the data fields in the web form displayed on the computing device from the said another computing device comprises:
comparing the unique code provided to the computing device with the unique code received from said another computing device; and
obtaining the personal information corresponding to the data fields in the web form displayed on the computing device from said another computing device if the unique code provided to the computing device matches with the unique code received from said another computing device.

15. The method of claim 13, wherein obtaining the personal information corresponding to the data fields in the web form from said another computing device comprises:
sending a request for personal information corresponding to the data fields in the web form to said another computing device; and
receiving the personal information corresponding to the data fields in the web form from said another computing device.

16. The method of claim 13, further comprising:
marking at least one type of the personal information as containing sensitive information.

17. The method of claim 16, further comprising:
generating a query on said another computing device to determine whether the at least one type of the personal information marked as sensitive information is allowed to be filled in the data fields of the web form.

18. The method of claim 13, further comprising:
recording history of web forms filled using the personal information stored in said another computing device.

19. The method of claim 13, further comprising:
creating a backup of the personal information stored in said another computing device.

20. The method of claim 19, further comprising:
restoring the backed up personal information in said another computing device.

21. An apparatus comprising:
a processor; and
a memory coupled to the processor, wherein the memory comprises an executable program stored in the form of instructions, which when executed by the processor, cause the processor to perform following steps comprising:
receiving a request for unique code from a computing device;
providing the unique code to the computing device in response to the received request;
receiving a unique code from another computing device;
dynamically obtaining personal information corresponding to data fields in a web form displayed on the computing device from the said another computing device if the unique code provided to the computing device matches with the unique code received from said another computing device; and
populating the personal information in the data fields of the web form.

22. The apparatus of claim 21, wherein in obtaining the personal information corresponding to the data fields in the web form displayed on the computing device from the said another computing device, the executable program cause the processor to perform the following steps comprising:
comparing the unique code provided to the computing device with the unique code received from said another computing device; and
obtaining the personal information corresponding to the data fields in the web form displayed on the computing device from said another computing device if the unique code provided to the computing device matches with the unique code received from said another computing device.

23. The apparatus of claim 21, wherein the executable program cause the processor to perform the following steps comprising:
marking at least one type of the personal information as containing sensitive information; and
generating a query on said another computing device to determine whether the at least one type of the personal information marked as sensitive information is allowed to be filled in the data fields of the web form.

24. The apparatus of claim 21, wherein the executable program cause the processor to perform the following steps comprising:
recording history of web forms filled using the personal information stored in said another computing device.

25. A method of securely storing information filled in a web form on a computing device, comprising:
receiving a request for unique code from a computing device;
providing the unique code to the computing device in response to the received request;
receiving a unique code from another computing device;
obtaining personal information filled in data fields of a web form displayed on the another computing device if the unique code provided to the computing device matches with the unique code received from said another computing device; and
providing the obtained personal information to the computing device.

26. The method of claim 25, wherein obtaining the personal information filled in the data fields of the web form displayed on said another computing device comprises:
comparing the unique code provided to the computing device with the unique code received from said another computing device; and
obtaining the personal information filed in the data fields of the web form displayed on said another computing device if the unique code provided to the computing device matches with the unique code received from said another computing device.

27. The method of claim 25, further comprising:
generating a query on said another computing device to determine whether at least one type of the personal information is to be marked as sensitive information.

28. An apparatus comprising:
a processor; and
a memory coupled to the processor, wherein the memory comprises an executable program stored in the form of instructions, which when executed by the processor, cause the processor to perform following steps comprising:
receiving a request for unique code from a computing device;
providing the unique code to the computing device in response to the received request;
receiving a unique code from another computing device;
obtaining personal information filled in data fields of a web form displayed on the another computing device if the unique code provided to the computing device matches with the unique code received from said another computing device; and
providing the obtained personal information to the computing device.

29. The apparatus of claim 28, wherein in obtaining the personal information filled in the data fields of the web form displayed on said another computing device, the executable program cause the processor to perform the following steps comprising:
comparing the unique code provided to the computing device with the unique code received from said another computing device; and
obtaining the personal information filed in the data fields of the web form displayed on said another computing device if the unique code provided to the computing device matches with the unique code received from said another computing device.

30. The apparatus of claim 28, wherein the executable program cause the processor to perform the following step comprising:
generating a query on said another computing device to determine whether at least one type of the personal information is to be marked as sensitive information.

31. A non-transitory computer-readable storage medium having instructions stored therein, which when executed by a processor, cause the processor to perform a method comprising:
receiving an unique code from a computing device;
validating the unique code received from the computing device; and
dynamically obtaining personal information from the computing device if the unique code is successfully validated.

32. The storage medium of claim 31, wherein the instructions cause the processor to perform the following steps comprising:
generating a unique code upon receiving a request for unique code from another computing device; and
providing the generated unique code to the user of said another computing device.
